(19) United States
(12) Patent Application Publication
(10) Pub. No.: US 2021/0319542 A1
(43) Pub. Date: Oct. 14, 2021

(54) IMAGE PROCESSING APPARATUS AND METHOD THEREOF

(71) Applicants: SK hynix Inc., Gyeonggi-do (KR); Seoul National University R&DB Foundation, Seoul (KR)

(72) Inventors: Nam Ik Cho, Seoul (KR); Sang Hoon Lee, Seoul (KR); Hae Soo Chung, Gyeonggi-do (KR)

(21) Appl. No.: 17/123,421

(22) Filed: Dec. 16, 2020

(30) Foreign Application Priority Data
Apr. 14, 2020 (KR) 10-2020-0045210
Nov. 25, 2020 (KR) 10-2020-0159825

(51) Int. Cl. G06T 5/00; G06T 5/50; G06T 7/30; G06T 11/00

(52) U.S. Cl. CPC G06T 5/009; G06T 5/50; G06T 7/30; G06T 2207/10144; G06T 2207/20208; G06T 2207/20081; G06T 11/00

(57) ABSTRACT

Disclosed is an image processing apparatus and method for generating one HDR image by using a plurality of LDR images photographed at different exposure values. The image processing apparatus may include a deep learning framework configured to receive a plurality of low dynamic range (LDR) images captured at different exposures, generate kernels for alignment by using the plurality of LDR images, generate aligned images by applying the kernels to the plurality of LDR images, and generate a high dynamic range (HDR) image by synthesizing the aligned images.

### CROSS-REFERENCE TO RELATED APPLICATION

This application claims priority under 35 U.S.C. § 119 to Korean Patent Application Nos. 10-2020-0045210 filed on Apr. 14, 2020 and 10-2020-0159825 filed on Nov. 25, 2020 which are incorporated herein by reference in its entirety.

### BACKGROUND

### 1. Field

Exemplary embodiments relate to an image processing apparatus and method, and more particularly, to an image processing apparatus and method for generating a high dynamic range (HDR) image by using a plurality of low dynamic range (LDR) images.

### 2. Discussion of the Related Art

In general, the dynamic range of brightness perceived by the human eye is very wide. However, images photographed by a general-purpose camera have a limited dynamic range due to the limitations of an image sensor. An image processing apparatus according to the related art is not able to properly express an area outside the dynamic range of the camera. Accordingly, there is a need for a technology that provides an HDR image in consideration of the current display environment and the dynamic range perceived by the human eye.

### RELATED ART DOCUMENTS

Patent Document 1: Korean Patent Application Laid-Open No. 10-2015-0132605 filed on Nov. 25, 2015
Patent Document 2: Korean Patent Application Laid-Open No. 10-2016-0138685 filed on Dec. 6, 2016

### SUMMARY

Various embodiments are directed to providing an image processing apparatus and method for generating one HDR image by using a plurality of LDR images captured at different exposures.

In an embodiment, there is provided an image processing apparatus may include a deep learning framework configured to receive a plurality of low dynamic range (LDR) images captured at different exposures, generate kernels for alignment by using the plurality of LDR images, generate aligned images by applying the kernels to the plurality of LDR images, and generate a high dynamic range (HDR) image by synthesizing the aligned images.

In an embodiment, there is provided an image processing method may include the steps of: receiving a plurality of low dynamic range (LDR) images captured at different exposures; generating kernels for alignment by using the plurality of LDR images; generating aligned images by applying the kernels to the plurality of LDR images; and generating a high dynamic range (HDR) image by synthesizing the aligned images.

In accordance with embodiments, it is possible to generate an HDR image having a wide dynamic range by constructing one deep learning framework including a process of aligning LDR images and a process of generating the HDR image by synthesizing the aligned images.

Furthermore, in accordance with embodiments, alignment is performed at a feature level in the deep learning framework, so that it is possible to minimize information loss of the LDR images.

Furthermore, in accordance with embodiments, kernels for respective pixels of the LDR images are generated and applied to the LDR images, so that precise alignment is possible and detailed information can also be preserved even when there is a large movement of an object.

Furthermore, in accordance with embodiments, it is possible to learn a series of processes of generating the HDR image from the LDR images through the deep learning framework at one time.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram for explaining an image processing apparatus in accordance with an embodiment.

FIG. 2 is a diagram for explaining a structure of an alignment module, such as that illustrated in FIG. 1.

FIG. 3 is a diagram for explaining a structure of a synthesis module, such as that illustrated in FIG. 1.

FIG. 4 is a flowchart for explaining an image processing method in accordance with an embodiment.

### DETAILED DESCRIPTION

Various embodiments are described below in detail with reference to the accompanying drawings such that the present disclosure can be practiced and easily carried out by those skilled in the art to which the present disclosure pertains. Like elements/components are designated by the same reference numerals throughout the figures. Also, throughout the specification, reference to “an embodiment” or the like is not necessarily to only one embodiment, and different references to any such phrase are not necessarily to the same embodiment(s). Also, “embodiments” does not necessarily mean all embodiments.

In the following description, detailed description of related publicly-known technologies may be omitted to avoid obscuring the subject matters of the present disclosure.

Terms such as first and second may be used to identify various components that otherwise have the same or similar names. However, such terms do not indicate any change in the components themselves, and thus the components are not limited by the terms.

Embodiments provide an image processing apparatus and method for aligning a plurality of low dynamic range (LDR) images captured or photographed at different exposures, i.e., with different exposure values, and synthesizing the aligned images, thereby generating one high dynamic range (HDR) image having a wide dynamic range.

In an embodiment, a deep learning framework 10 may be defined as a network that performs deep learning in an image processing apparatus 100 based on information of LDR images X1 to X3 inputted.

In an embodiment, the deep learning framework 10 may include a kernel prediction network for alignment and a synthesis network for synthesis. Such kernel prediction network and synthesis network may include one or more layers that perform a convolution operation, a pooling operation, a bilinear upsampling operation, and/or a weighted average sum operation. Furthermore, the kernel prediction network and the synthesis network may concatenate each layer through a skip connection. The skip connection may be defined as an operation of skipping an unuseful layer in order to optimally tune the number of layers during deep learning.

In an embodiment, kernels K1 to K3 may be defined as filters for aligning the LDR images X1 to X3, respectively, through deep learning. Such kernels K1 to K3 may be generated for each of pixels of each of the LDR images X1 to X3. For example, kernels K1 to K3 may be generated through deep learning based on information of corresponding pixels of the LDR images X1 to X3 and information of surrounding pixels (or information on peripheries) of the corresponding pixels. Here, the information of the corresponding pixels and the information of the surrounding pixels may be RGB values.

In an embodiment, values of the kernels K1 to K3 may be changed according to the information of the corresponding pixels of the LDR images X1 to X3 and the information of the surrounding pixels of the corresponding pixels.

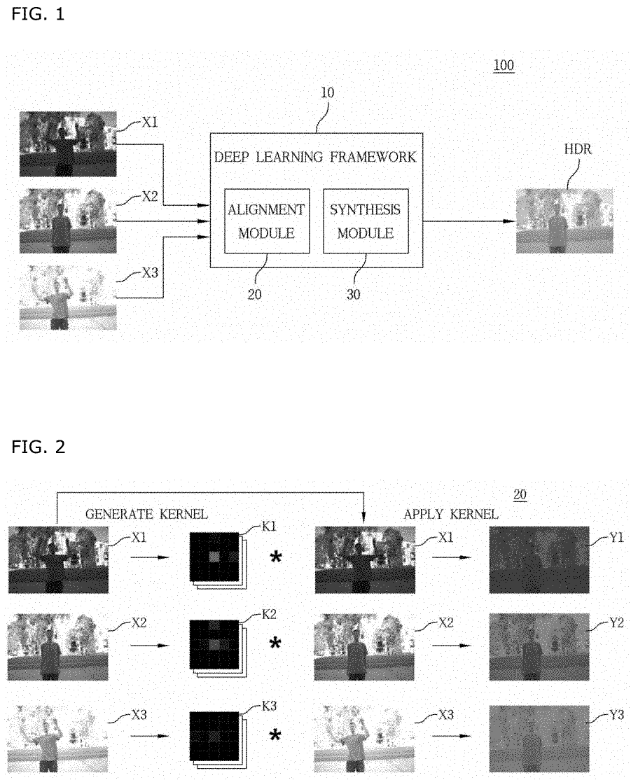

FIG. 1 is a block diagram for explaining the image processing apparatus 100 in accordance with an embodiment.

Referring to FIG. 1, the image processing apparatus 100 includes the deep learning framework 10 that generates one HDR image by using the LDR images X1 to X3. By way of example, FIG. 1 illustrates that three LDR images X1 to X3 are received and one HDR image is generated using the three LDR images X1 to X3. However, the invention is not limited to that specific configuration. In general, two or more LDR images may be used to generate one HDR image.

In accordance with embodiments, in order to solve a misalignment problem due to movement of object(s) and the camera and a ghosting artifact problem, it is possible to generate the HDR image through a method of aligning and synthesizing the LDR images through deep learning.

The deep learning framework 10 may include a process of aligning the LDR images X1 to X3 and a process of generating the HDR image by synthesizing the aligned images.

Such a deep learning framework 10 may use a method of obtaining RGB values of the corresponding pixels and RGB values of the surrounding pixels of the corresponding pixels from the plurality of LDR images X1 to X3 photographed at different exposures, i.e., with different exposure values. And, the deep learning framework 10 may align and synthesize the LDR images X1 to X3 through deep learning based on RGB values of the corresponding pixels and RGB values of the surrounding pixels of the corresponding pixels as if the LDR images X1 to X3 have been photographed at substantially the same time and position.

The deep learning framework 10 may generate the kernels K1 to K3 (illustrated in FIG. 2) by performing deep learning based on the RGB values of the corresponding pixels of the LDR images X1 to X3 and RGB values of the surrounding pixels of the corresponding pixels.

Here, the deep learning framework 10 may generate the kernels K1 to K3 for each of the pixels of each of the LDR images X1 to X3. That is, each of K1, K2 and K3 include multiple pixel-level kernels, one for each pixel of the corresponding LDR image. The kernels K1 to K3 may serve as filters for aligning the LDR images X1 to X3, may be generated through deep learning based on the information of the corresponding pixels of the LDR images X1 to X3 and the information of the surrounding pixels of the corresponding pixels, and may be changed according to the information of the corresponding pixels and the information of the surrounding pixels thereof.

Furthermore, the deep learning framework 10 may align the LDR images X1 to X3 based on one of the LDR images X1 to X3. As an example, the deep learning framework 10 may align the LDR images X1 to X3 based on the LDR image X2 photographed with an intermediate exposure value among the LDR images X1 to X3.

As an example, the deep learning framework 10 may extract features of a moving object by applying the kernels K1 to K3 to the LDR images X1 to X3, and align the backgrounds of the LDR images X1 to X3 based on the moving object of the LDR image X2 photographed with the intermediate exposure value.

Furthermore, the deep learning framework 10 may generate a weight map by performing deep learning based on RGB values of pixels of the aligned images Y1, Y2 and Y3, and generate an HDR image by performing a weighted average sum operation on the aligned images Y1, Y2 and Y3 by using the weight map.

Such a deep learning framework 10 may include an alignment module 20 and a synthesis module 30. Here, a module may be defined as a unit of a computer system or program having a specific function.

The alignment module 20 may receive the plurality of LDR images X1 to X3 photographed at different exposures, i.e., with different exposure values, and align the plurality of LDR images X1 to X3 as if the LDR images X1 to X3 have been photographed at substantially the same time and position.

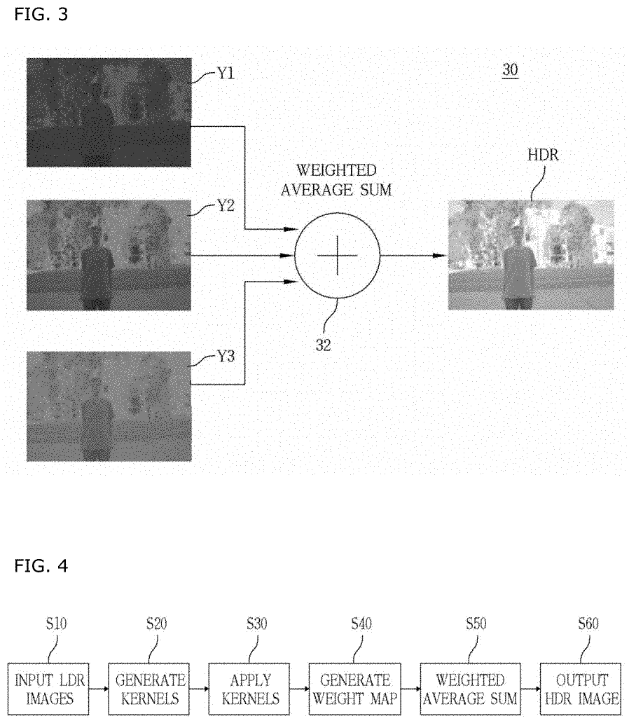

The synthesis module 30 may synthesize the aligned images and generate one HDR image having a wide dynamic range. The alignment module 20 may be configured as illustrated in FIG. 2 and the synthesis module 30 may be configured as illustrated in FIG. 3.

FIG. 2 is a diagram for explaining the structure of the alignment module 20 illustrated in FIG. 1.

Referring to FIG. 2, the alignment module 20 may generate the kernels K1 to K3, which are applicable to each image, by using the LDR images X1 to X3. The alignment module 20 may adaptively generate the kernels K1 to K3 differently for respective pixels of the LDR images by using the deep learning.

As an example, the alignment module 20 may perform the deep learning by using the information of the pixels of the LDR images X1 to X3 and the surrounding information of the pixels, and generate the kernels K1 to K3 for the respective pixels of the LDR images X1 to X3 through the deep learning.

Then, the alignment module 20 may generate aligned images Y1 to Y3 by applying the kernels K1 to K3 to corresponding pixels of the LDR images. In such a case, the alignment module 20 may align the images based on an image photographed with an intermediate exposure value among the LDR images.

As an example, the alignment module 20 may generate the aligned images Y1 to Y3 by aligning the LDR images X1 to X3 based on the LDR image X2 photographed with the intermediate exposure value among the LDR images X1 to X3.

As an example, the alignment module 20 may extract features of a moving object by applying the kernels K1 to K3 to the LDR images X1 to X3, and align the backgrounds of the LDR images X1 to X3 based on the moving object of the LDR image X2 photographed with the intermediate exposure value.

Such an alignment module 20 may include a kernel prediction network. The kernel prediction network may perform a convolution operation, an average pooling operation, a bilinear upsampling operation and/or a skip connection based on the RGB values of the corresponding pixels of the LDR images X1 to X3 and the RGB values of surrounding the pixels of the corresponding pixels. And, the kernel prediction network may concatenate each layer through a skip connection. That is, the kernel prediction network has the skip connection in which skip an unuseful layer in order to optimally tune the number of layers during deep learning.

As an example, the kernel prediction network may include a convolution layer, an average pooling layer, the skip connection, and/or a bilinear upsampling layer. Each layer may be configured in multiple instances.

FIG. 3 is a diagram for explaining the structure of the synthesis module 30 illustrated in FIG. 1.

Referring to FIG. 3, the synthesis module 30 may generate an HDR image by performing the weighted average sum operation on the aligned images Y1 to Y3.

Such a synthesis module 30 may generate a weight map by performing the deep learning on RGB values of pixels of the aligned images Y1 to Y3, and generate the HDR image by performing the weighted average sum operation on the aligned images Y1 to Y3 by using the weight map.

The synthesis module 30 may generate the HDR image using the weighted average sum operation that multiplies the weighted maps by the aligned images Y1 to Y3 and then sums them. The weighted maps may be generated by deep learning each of the aligned images Y1 to Y3. Here, the weighted maps may indicate how much of each aligned image Y1 to Y3 is to be reflected to the HDR image. Through such an image synthesis process, a final HDR image may be generated.

As an example, the synthesis module 30 may include a merging network. The merging network may include at least one layer 32 that performs the weighted average sum operation.

As described above, in accordance with embodiments, the LDR images X1 to X3 photographed at different exposures, i.e., with different exposure values, may be received and the kernels K1 to K3 for alignment may be generated using the LDR images X1 to X3.

Furthermore, in accordance with embodiments, the aligned images Y1 to Y3 may be generated by applying the kernels K1 to K3 to the LDR images X1 to X3, and the HDR image may be generated by performing the weighted average sum operation on the aligned images Y1 to Y3.

FIG. 4 is a flowchart for explaining an image processing method in accordance with an embodiment.

Referring to FIG. 4, the deep learning framework 10 may receive the LDR images X1 to X3 photographed at different exposures, i.e., with different exposure values (S10).

Then, the deep learning framework 10 may generate the kernels K1 to K3 for aligning the LDR images X1 to X3 by performing the deep learning based on the RGB values of the corresponding pixels of the LDR images X1 to X3 and the RGB values of the surrounding pixels of the corresponding pixels (S20). The kernels K1 to K3 may be generated differently for respective pixels of the LDR images X1 to X3 through the deep learning.

Then, the deep learning framework 10 may generate the aligned images Y1 to Y3 by applying the kernels K1 to K3 to the LDR images X1 to X3 (S30). As an example, the deep learning framework 10 may generate the aligned images Y1 to Y3 by multiplying values of pixels of the LDR images X1 to X3 by values of the kernels K1 to K3 corresponding to each of the pixels.

Then, the deep learning framework 10 may generate a weight map by performing the deep learning based on the information of the aligned images Y1 to Y3 (S40).

Then, the deep learning framework 10 may perform the weighted average sum operation on the aligned images Y1 to Y3 by using the weight map (S50).

Then, the deep learning framework 10 may output an HDR image, which is synthesized by performing the weighted average sum operation on the aligned images Y1 to Y3 (S60).

As described above, the deep learning framework 10 may generate the kernels K1 to K3 for alignment through deep learning when the LDR images X1 to X3 are inputted, and generate the aligned images Y1 to Y3 by applying the kernels K1 to K3 to the LDR images X1 to X3.

Then, the deep learning framework 10 may multiply the aligned images Y1 to Y3 by the weight map, add the multiplied images together, and output a final HDR image. The deep learning framework 10 may learn the entire process of generating the HDR image from the LDR images X1 to X3 through the deep learning at one time.

In accordance with such embodiments, it is possible to generate an HDR image in all cases where the LDR images X1 to X3 may be photographed at different exposures, and thus embodiments of the present invention are applicable throughout the field of image processing.

Moreover, an HDR image may be synthesized by pre-aligning LDR images by using homography transformation or optical flow. However, a method using the homography transformation has a disadvantage in that it is difficult to solve a problem in which an object moves a relatively large distance, and information loss in an edge portion inevitably occurs. Furthermore, the method using the optical flow may cause distortion or additional artifacts.

In accordance with embodiments, unlike the method using the homography transformation or the optical flow, it is possible to generate the kernels K1 to K3 for respective pixels of the LDR images X1 to X3 and align the LDR images X1 to X3 by applying the kernels K1 to K3 to the LDR images X1 to X3, so that it is possible to generate an HDR image without distortion or additional artifacts even when there is misalignment due to large movement of an object and movement of a background.

Furthermore, in accordance with embodiments, it is possible to directly generate an HDR image from unaligned LDR images X1 to X3. That is, even if there is movement of an object between the LDR images X1 to X3, it is possible to generate the HDR image from the LDR images X1 to X3 having movement through the one deep learning framework 10 without the pre-alignment process.

As described above, in accordance with embodiments, it is possible to generate an HDR image having a wide dynamic range by constructing one deep learning framework 10 including a process of aligning the LDR images X1 to X3 and a process of generating the HDR image by synthesizing the aligned images.

Furthermore, in accordance with embodiments, alignment is performed at a feature level in the deep learning framework 10, so that it is possible to minimize information loss of the LDR images X1 to X3.

Furthermore, in accordance with embodiments, kernels for respective pixels of the LDR images are generated and applied to the LDR images, so that precise alignment is possible and detailed information can also be preserved well even when there is large movement of an object.

Furthermore, in accordance with embodiments, it is possible to learn a series of processes of generating the HDR image from the LDR images through the deep learning framework 10 at one time.

While the present invention has been illustrated and described in connection with various embodiments, those skilled in the art will understand that any of the disclosed embodiments may be modified in various ways without departing from the spirit and scope of the present invention. The present invention encompasses all such modifications to the extent they fall within the scope of the claims.

What is claimed is:

1. An image processing apparatus comprising:
a deep learning framework configured to receive a plurality of low dynamic range (LDR) images captured at different exposures, generate kernels for alignment by using the plurality of LDR images, generate aligned images by applying the kernels to the plurality of LDR images, and generate a high dynamic range (HDR) image by synthesizing the aligned images.

2. The image processing apparatus of claim 1, wherein the deep learning framework generates the kernels by performing deep learning based on information of pixels of the plurality of LDR images and information of surrounding pixels of the pixels.

3. The image processing apparatus of claim 2, wherein the deep learning framework generates the kernels for each of the pixels of each of the plurality of LDR images.

4. The image processing apparatus of claim 1, wherein the deep learning framework is further configured to align the plurality of LDR images based on one LDR image among the plurality of LDR images to generate the aligned images.

5. The image processing apparatus of claim 1, wherein the one LDR image serving as a reference is an image captured at an intermediate exposure among the plurality of LDR images captured at the different exposures.

6. The image processing apparatus of claim 1, wherein the deep learning framework is further configured to generate a weight map by performing deep learning based on information of the aligned images.

7. The image processing apparatus of claim 6, wherein the deep learning framework generates the HDR image by performing a weighted average sum operation on the aligned images by using the weight map.

8. The image processing apparatus of claim 1, wherein the deep learning framework comprises:
an alignment module configured to generate the kernels by performing deep learning on information of pixels of the LDR images and information of surrounding pixels of the pixels, and generate the aligned images by applying the kernels to the plurality of LDR images; and
a synthesis module configured to generate a weight map by performing deep learning on information of the aligned images, and generate the HDR image by performing the weighted average sum operation on the aligned images by using the weight map.

9. An image processing method comprising the steps of:
receiving a plurality of low dynamic range (LDR) images captured at different exposures;
generating kernels for alignment by using the plurality of LDR images;
generating aligned images by applying the kernels to the plurality of LDR images; and
generating a high dynamic range (HDR) image by synthesizing the aligned images.

10. The image processing method of claim 9, wherein, in the step of generating the kernels, the kernels are generated by performing deep learning based on information of pixels of the plurality of LDR images and information of surrounding pixels of the pixels.

11. The image processing method of claim 10, wherein, in the step of generating the kernels, the kernels are generated for each of the pixels of each of the plurality of LDR images.

12. The image processing method of claim 9, wherein the step of generating the aligned images includes aligning the plurality of LDR images based on one LDR image captured at an intermediate exposure among the plurality of LDR images.

13. The image processing method of claim 9, wherein the step of generating the HDR image includes generating a weight map by performing deep learning based on information of the aligned images.

14. The image processing method of claim 13, wherein, in the step of generating the HDR image, the HDR image is generated by performing a weighted average sum operation on the aligned images by using the weight map.

15. An operating method of an image processor, the operating method comprising:
generating aligned images from low dynamic range (LDR) images according to kernels corresponding to the LDR images, respectively using deep learning; and
generating a high dynamic range (HDR) image from the aligned images using deep learning.
